(19) United States
(12) Patent Application Publication
(10) Pub. No.: US 2010/0131679 A1
(43) Pub. Date: May 27, 2010

(54) APPARATUS FOR PERFORMING A DOWNLINK OR UPLINK PROCESSING IN A WIRELESS COMMUNICATION SYSTEM TO MAINTAIN THE EFFICIENCY OF SYSTEM BANDWIDTH, AND ASSOCIATED METHODS

(76) Inventor: Jian-Bang Lin, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/276,420

(22) Filed: Nov. 24, 2008

(51) Int. Cl. G06F 13/28

(52) U.S. Cl. 710/26

(57) ABSTRACT

An apparatus for performing downlink or uplink processing in a wireless communication system to maintain efficiency of system bandwidth includes at least one sharing-ring buffer, a MAC-PHY interface, a security engine, and a DMA processor. The sharing-ring buffer is for storing multi-format data. In a situation where the apparatus performs downlink processing, the MAC-PHY interface is for receiving input data, the security engine is for retrieving stored data from the sharing-ring buffer and decrypting the retrieved data, and the DMA processor is for accessing the sharing-ring buffer to obtain the decrypted data. In a situation where the apparatus performs uplink processing, the DMA processor is for receiving input data and storing the input data into the sharing-ring buffer, the security engine is for retrieving the stored data from the sharing-ring buffer and encrypting the retrieved data, and the MAC-PHY interface is for receiving the encrypted data from the sharing-ring buffer.

### BACKGROUND

The present invention relates to wireless communication, and more particularly, to apparatus for performing a downlink or uplink processing in a wireless communication system to maintain the efficiency of system bandwidth, and to associated methods.

FIG. 1 illustrates a frame structure typically utilized in a wireless communication system such as a Worldwide Interoperability Microwave Access (WiMAX) communication system according to the related art, where the WiMAX communication system may communicate by utilizing downlink (DL) bursts and uplink (UL) bursts according to the frame structure shown in FIG. 1. An example of a medium access control (MAC) header of a MAC protocol data unit (PDU) typically utilized in a DL burst format for the frame structure shown in FIG. 1 is further illustrated as shown in FIG. 2.

According to the related art, a WiMAX MAC circuit typically comprises a plurality of stages of a receiving (Rx) path and further comprises a plurality of stages of a transmitting (Tx) path. As the stages in each of the Rx and Tx paths are successively arranged, and as the stages in each path need to operate in series regarding a specific unit of data, it is hard to further increase the overall operational speed of the WiMAX MAC circuit. In addition, regarding the Rx path, multiple buffers such as First In First Out memories are required for the stages. For better performance of the Rx path, the respective storage volumes of the buffers should not be too small, causing a poor possibility of decreasing the size of the WiMAX MAC circuit.

### SUMMARY

It is therefore an objective of the claimed invention to provide an apparatus for performing a downlink or uplink processing in a wireless communication system to maintain the efficiency of system bandwidth, and to provide associated methods, in order to solve the above-mentioned problem.

An exemplary embodiment of an apparatus for performing a downlink processing in a wireless communication system to maintain the efficiency of system bandwidth comprises a sharing-ring buffer, a Medium Access Control and Physical layers (MAC-PHY) interface, a security engine, and a direct memory access (DMA) processor. The sharing-ring buffer is utilized for storing multi-format data. The MAC-PHY interface is utilized for receiving input data, wherein the input data comprises at least a data burst, is in a data burst format and is stored into the sharing-ring buffer. In addition, the security engine is utilized for retrieving the stored data from the sharing-ring buffer and decrypting the retrieved data, wherein the decrypted data is in a protocol data unit (PDU) format and stored into the sharing-ring buffer. Additionally, the DMA processor is utilized for accessing the sharing-ring buffer to obtain the decrypted data.

An exemplary embodiment of an apparatus for performing an uplink processing in a wireless communication system to maintain the efficiency of system bandwidth comprises a sharing-ring buffer, a MAC-PHY interface, a security engine, and a DMA processor. The sharing-ring buffer is utilized for storing multi-format data. The DMA processor is utilized for receiving input data and storing the input data into the sharing-ring buffer, wherein the input data is in a PDU format and is stored into the sharing-ring buffer. In addition, the security engine is utilized for retrieving the stored data from the sharing-ring buffer and encrypting the retrieved data, wherein the encrypted data is stored into the sharing-ring buffer and the encrypted data is translated into a data burst format prior of storing into the sharing-ring buffer. Additionally, the MAC-PHY interface is utilized for receiving the encrypted data from the sharing-ring buffer.

An exemplary embodiment of a method for processing data in a wireless communication system comprises providing a sharing-ring buffer for storing multi-format data, and receiving input data, wherein the input data comprises at least a data burst and the input data is stored into the sharing-ring buffer. In addition, the method further comprises retrieving the stored data from the sharing-ring buffer, decrypting the retrieved data and storing the decrypted data into the sharing-ring buffer, and accessing the sharing-ring buffer to obtain the decrypted data for processing.

An exemplary embodiment of a method for processing data in a wireless communication system comprises providing a sharing-ring buffer for storing at least one type of data, and receiving input data, wherein the input data are in a PDU format and the input data is stored into the sharing-ring buffer. In addition, the method further comprises retrieving the stored data from the sharing-ring buffer, and encrypting the retrieved data and storing the encrypted data into the sharing-ring buffer, wherein the encrypted data is in a data burst format. Additionally, the method further comprises accessing the sharing-ring buffer to obtain the encrypted data for transmitting the encrypted data to a baseband.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a frame structure typically utilized in a wireless communication system such as a Worldwide Interoperability Microwave Access (WiMAX) communication system according to the related art.

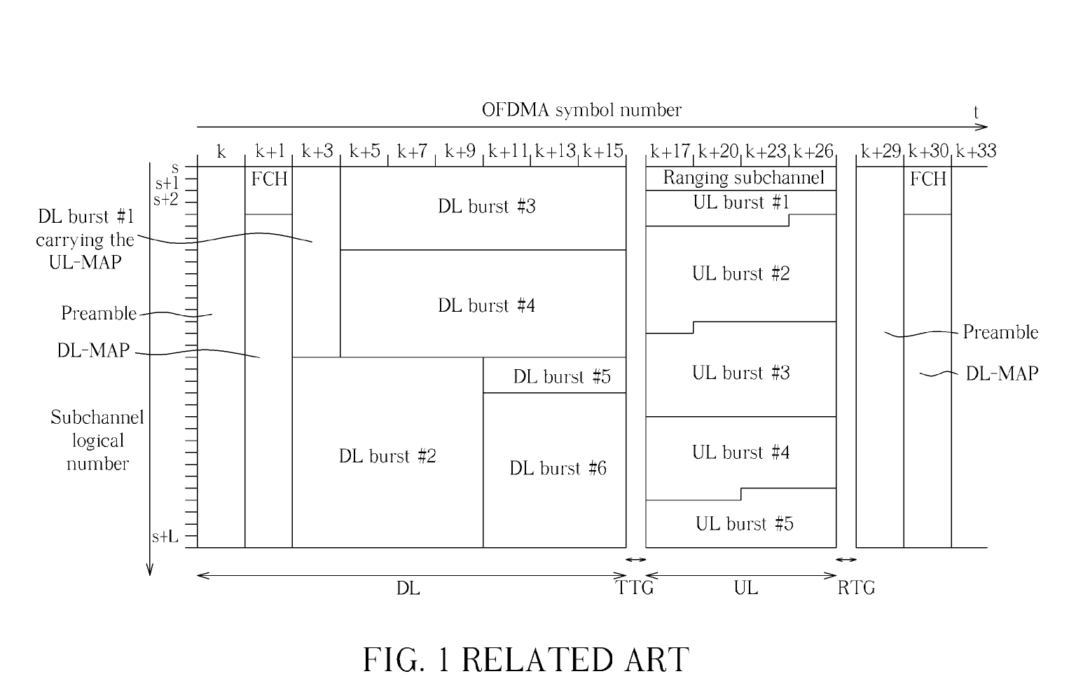

FIG. 2 illustrates an example of a medium access control (MAC) header of a MAC protocol data unit (PDU) typically utilized in a downlink (DL) burst format for the frame structure shown in FIG. 1.

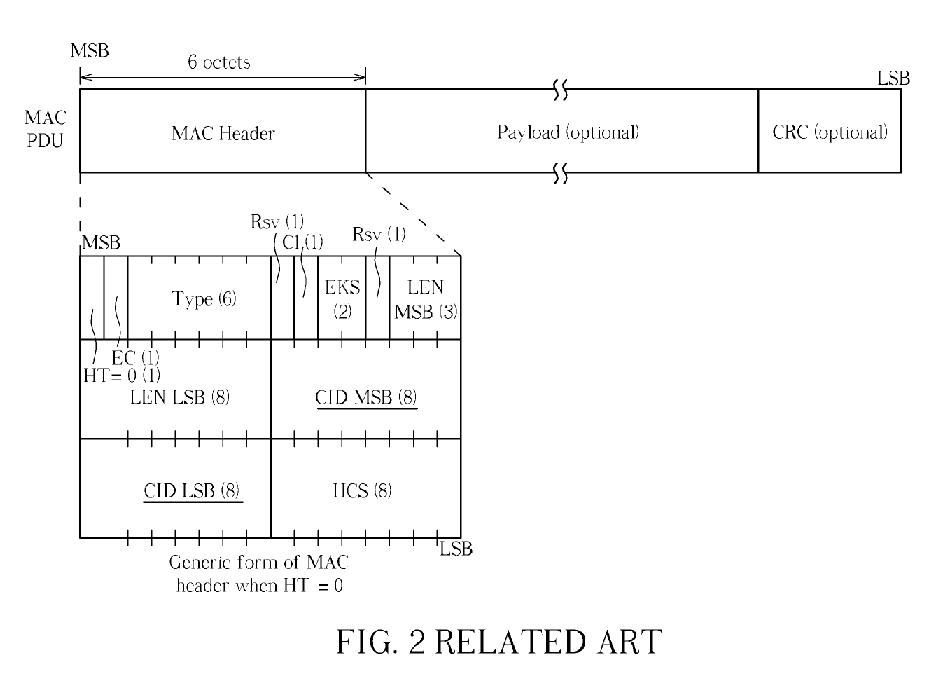

FIG. 3 is a diagram of an apparatus for performing downlink or uplink processing in a wireless communication system to maintain efficiency of system bandwidth according to a first embodiment of the present invention.

FIG. 4 is a flowchart of a method for processing data in a wireless communication system according to an embodiment of the present invention, where this flowchart corresponds to a receiving (Rx) path of the wireless communication system.

FIG. 5 is a flowchart of a method for processing data in a wireless communication system according to another embodiment of the present invention, where this flowchart corresponds to a transmitting (Tx) path of the wireless communication system.

FIG. 6 illustrates practical system architecture of the apparatus shown in FIG. 3 according to one embodiment of the present invention.

FIG. 7 illustrates overlapped processing phases of respective schemes of the Rx burst controller shown in FIG. 6 according to a special case of the embodiment shown in FIG. 6.

FIG. 8 illustrates the buffer structure for the Rx burst controller shown in FIG. 6.

FIG. 9 illustrates overlapped processing phases of respective schemes of the Tx burst controller shown in FIG. 6 according to another special case of the embodiment shown in FIG. 6.

FIG. 10 illustrates the buffer structure for the Tx burst controller shown in FIG. 6.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

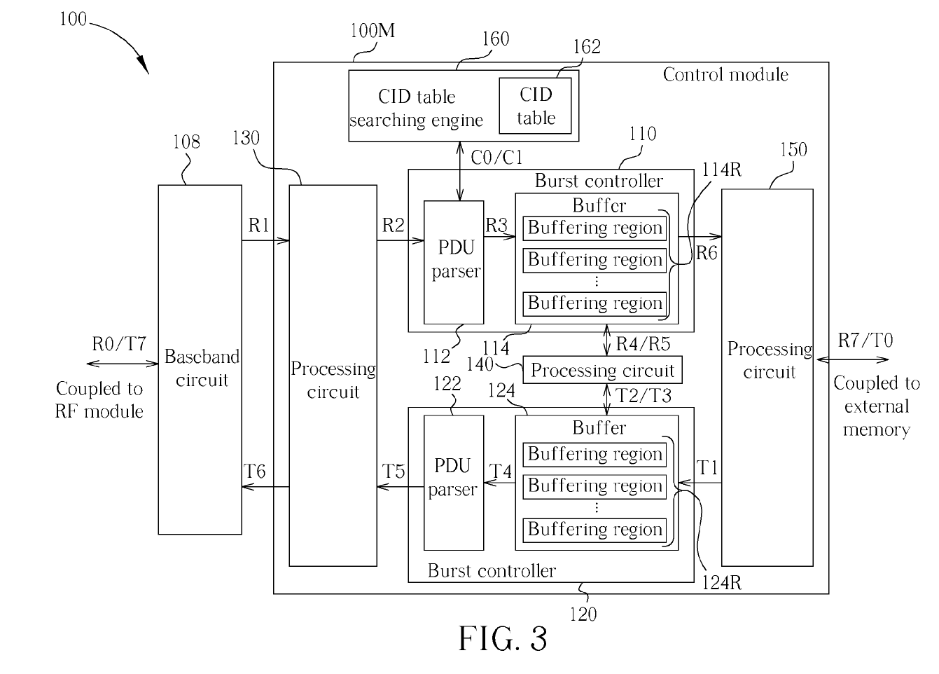

Please refer to FIG. 3. FIG. 3 is a diagram of an apparatus 100 for performing downlink or uplink processing in a wireless communication system such as a Worldwide Interoperability Microwave Access (WiMAX) communication system to maintain the efficiency of system bandwidth according to a first embodiment of the present invention, where the apparatus 100 of this embodiment comprises a control module 100M and a baseband circuit 108. In this embodiment, at least a portion of the apparatus 100 (e.g., the control module 100M and/or the baseband circuit 108) is implemented with an integrated circuit (IC).

According to an implementation choice of the first embodiment, the apparatus 100 may represent the wireless communication system, but this is not a limitation of the present invention. According to another implementation choice of the first embodiment, the apparatus 100 may comprise the wireless communication system. For example, the apparatus 100 can be a multi-function device comprising cellular phone functionality, personal digital assistant (PDA) functionality, and WiMAX communication functionality. In another embodiment of the present invention, the apparatus 100 may represent a portion of the wireless communication system (for example, the control module 100M shown in FIG. 3).

According to the first embodiment, the control module 100M of the apparatus 100 comprises a set of protocol data unit (PDU) parsers 112 and 122, at least one sharing-ring buffer (such as a set of buffers 114 and 124), a plurality of processing circuits such as processing circuits 130, 140, and 150, and a connection identification (CID) table search engine 160 comprising a CID table 162. As shown in FIG. 3, the PDU parser 112 and the buffer 114 are integrated into a burst controller 110, and the PDU parser 122 and the buffer 124 are integrated into a burst controller 120.

Regarding the upper portion of the control module 100M shown in FIG. 3, the buffer 114 comprises a plurality of buffering regions 114R for temporarily storing data corresponding to logically successive stages of a receiving (Rx) path of the wireless communication system, respectively. As shown in FIG. 3, the Rx path of this embodiment comprises data paths R0, R1, . . . , and R7, which are listed in accordance with the order of the logically successive stages of the Rx path. Along the Rx path, the PDU parser 112 parses one or more sub-units of data of a received PDU to one of the buffering regions 114R of the buffer 114. For example, one or more bytes are temporarily stored in each of the buffering regions that are involved.

In addition, regarding the lower portion of the control module 100M shown in FIG. 3, the buffer 124 comprises a plurality of buffering regions 124R for temporarily storing data corresponding to logically successive stages of a transmitting (Tx) path of the wireless communication system, respectively. As shown in FIG. 3, the Tx path of this embodiment comprises data paths T0, T1, . . . , and T7, which are listed in accordance with the order of the logically successive stages of the Tx path. Along the Tx path, the PDU parser 122 parses one or more sub-units of data of a PDU from one of the buffering regions 124R of the buffer 124. For example, one or more bytes are temporarily stored in each of the buffering regions that are involved, so as to be parsed by the PDU parser 122.

According to the first embodiment, the plurality of processing circuits 130, 140, and 150 are utilized for implementing the logically successive stages of the Rx/Tx path of the wireless communication system, respectively. The processing circuits 130, 140, and 150 of this embodiment emulate the logically successive stages of the Rx path by accessing the buffering regions 114R of the buffer 114 in rotation, and emulate the logically successive stages of the Tx path by accessing the buffering regions 124R of the buffer 124 in rotation.

More particularly in this embodiment, the buffer 114 can be referred to as the Rx-buffer, and the buffer 124 can be referred to as the Tx-buffer. In addition, the processing circuits 130, 140, and 150 emulate the logically successive stages of the Rx path by respectively accessing the buffering regions of the Rx-buffer, and emulate the logically successive stages of the Tx path by respectively accessing the buffering regions of the Tx-buffer, where the processing circuits 130, 140, and 150 do not need to operate in series.

For example, regarding the Rx path, after the processing circuit 130 starts its own operation for a specific unit of data (e.g., a PDU), the processing circuit 140 starts to access the first portion of the specific unit of data from one of the buffering regions 114R, in order to starts its own operation for the specific unit of data as soon as possible without waiting for the completion of the operation that the processing circuit 130 performs on the specific unit of data.

Similarly, still regarding the Rx path, after the processing circuit 140 starts its own operation for the specific unit of data, the processing circuit 150 starts to access the first portion of the specific unit of data from one of the buffering regions 114R (more particularly, the one of the buffering regions 114R), in order to starts its own operation for the specific unit of data as soon as possible without waiting for the completion of the operation that the processing circuit 140 performs on the specific unit of data.

As operations for the Tx path are the reversed operations for the Rx path with the data paths R0, R1, . . . , and R7 corresponding to the data paths T7, T6, . . . , and T0, respectively, similar descriptions are not repeated for the Tx path. Such schemes provide an increased overall operational speed of the wireless communication system in contrast to the related art, and therefore, provide better performance than the related art.

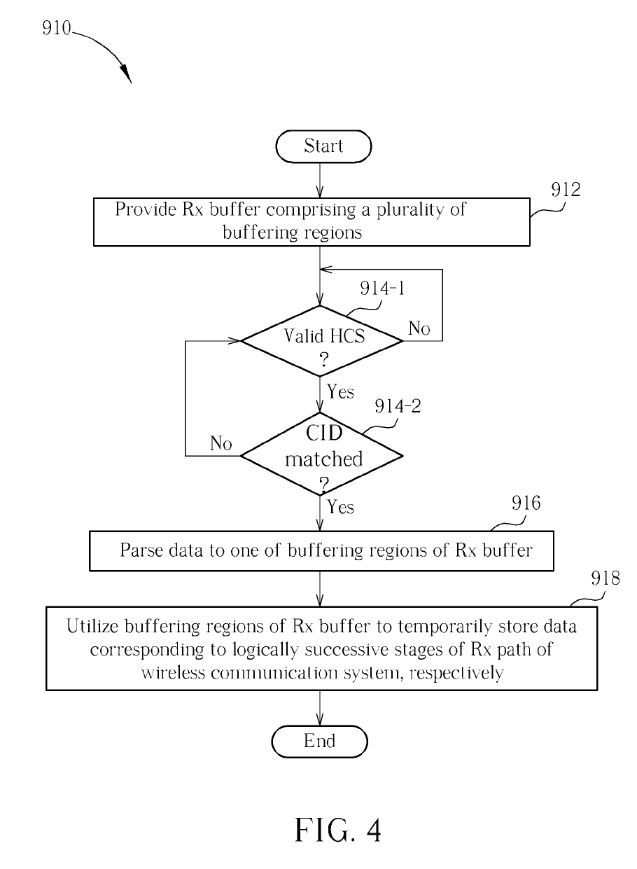

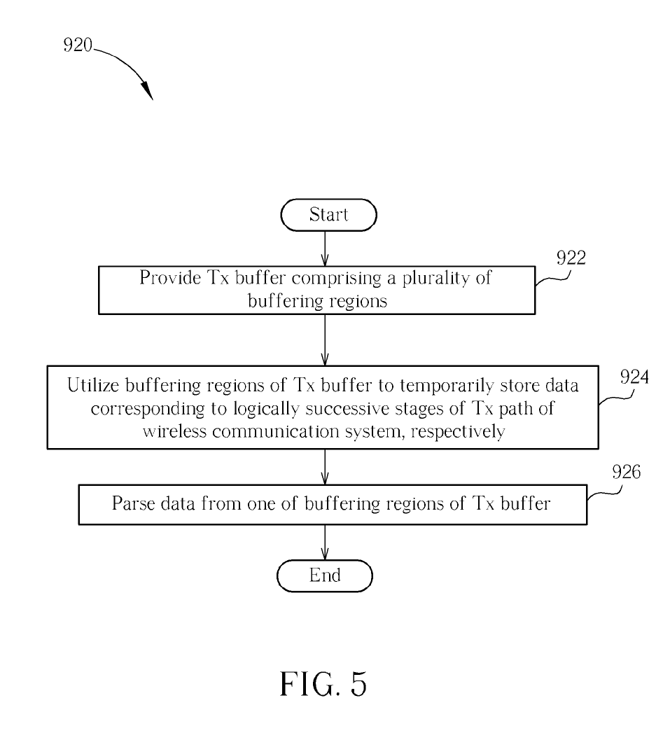

Please refer to FIG. 4 and FIG. 5. FIG. 4 is a flowchart of a method 910 for processing data in a wireless communication system according to an embodiment of the present invention, where this flowchart corresponds to a Rx path of the wireless communication system. FIG. 5 is a flowchart of a method 920 for processing data in a wireless communication system according to another embodiment of the present invention, where this flowchart corresponds to a Tx path of the wireless communication system. Both the method 910 and the method 920 can be applied to the first embodiment, and can be implemented with the apparatus 100 shown in FIG. 3.

It should be noted that Step 914-1 and Step 914-2 respectively correspond to the header check sequence (HCS) and CID detection operations performed on the fly within the apparatus 100. In Step 914-1, the PDU parser 112 detects whether a valid HCS received from the data path R2 exists. If the PDU parser 112 determines that there exists a valid HCS, the control paths C0 and C1 become active, and Step 914-2 is entered; otherwise, Step 914-1 is re-entered for repeating the HCS detection operation.

In Step 914-2, the CID table search engine 160 determines whether a CID of a received PDU from the control path CO matches a CID in the CID table 162 of the CID table search engine 160. The CID table search engine 160 sends a detection result back to the PDU parser 112 via the control path C1. When the CID of the received PDU does not match any CID in the CID table 162, the PDU parser 112 discards the received PDU. If the CID of the received PDU matches a CID in the CID table 162, the PDU parser 112 parses the data of the received PDU to the buffering regions 114R of the buffer 114, and Step 916 is entered; otherwise, Step 914-1 is re-entered.

As the other steps of the method 910 and the steps of the method 920 have been disclosed in the first embodiment, similar descriptions are not repeated for the embodiments shown in FIG. 4 and FIG. 5, respectively.

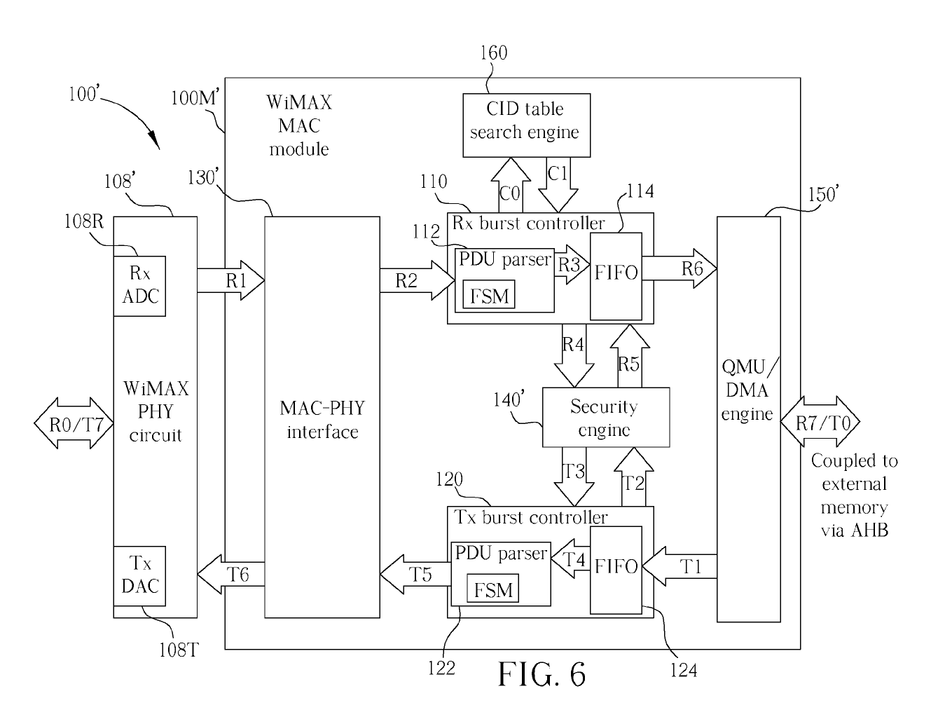

FIG. 6 illustrates practical system architecture of the apparatus 100 shown in FIG. 3 according to one embodiment of the present invention, where this embodiment is a special case of the apparatus 100 shown in FIG. 3. The control module 100M and the apparatus 100 in this special case are referred to as the WiMAX MAC module 100M′ and the apparatus 100′, respectively. Here, the aforementioned burst controllers 110 and 120 are referred to as the Rx burst controller and the Tx burst controller since they operate on the Rx path and the Tx path, respectively. In addition, the buffers 114 and 124 of this embodiment are implemented with First In First Out memories (FIFOs).

In this embodiment, the baseband circuit 108 mentioned above is implemented as a WiMAX PHY circuit 108′, where the WiMAX PHY circuit 108′ comprises a Rx Analog-to-Digital Converter (ADC) 108R and a Tx DAC 108T respectively for the data paths R0 and T7. In addition, the processing circuits 130, 140, and 150 mentioned above are respectively implemented as a Medium Access Control and Physical layers (MAC-PHY) interface 130′, a security engine 140′, and a direct memory access (DMA) processor such as a Queue Management Unit (QMU)/DMA engine 150′. The QMU/DMA engine 150′ of this embodiment is coupled to the external memory via an Advanced High-performance Bus (AHB).

According to this embodiment, the MAC-PHY interface 130′ is utilized for coupling the PDU parsers 112 and 122 to a baseband circuit within the wireless communication system, e.g., the WiMAX PHY circuit 108′. The security engine 140′ is utilized for encryption of the Tx path, and is also utilized for decryption of the Rx path. The QMU/DMA engine 150′ is utilized for writing data to the external memory of the wireless communication system regarding the Rx path, and is also utilized for reading data from the external memory of the wireless communication system regarding the Tx path. In addition, The MAC-PHY interface 130′ of the present invention can be either synchronous or asynchronous and the security engine 140′ of the present invention can process in real-time, off-line, or even simultaneously in real-time and off-line.

In this embodiment, the aforementioned sharing-ring buffer is implemented as the FIFOs 114 and 124 (which are respectively the Rx-buffer and the Tx-buffer of this embodiment), and is arranged to store multi-format data or at least one type of data, where the sharing-ring buffer comprises a plurality of buffering regions such as those shown in FIG. 3. Regarding a downlink processing and an uplink processing performed by the apparatus 100′, detailed operations thereof are explained as follows.

In a situation where the apparatus 100′ performs the downlink processing, the MAC-PHY interface 130′ is arranged to receive input data, where the input data comprises at least a data burst, is in a data burst format and is stored into the sharing-ring buffer. More particularly, the input data is stored into the FIFO 114 in this situation. In addition, the security engine 140′ is arranged to retrieve the stored data from the sharing-ring buffer (e.g., the FIFO 114 in this situation) and is arranged to decrypt the retrieved data, where the decrypted data is in a PDU format and stored into the sharing-ring buffer (e.g., the FIFO 114 in this situation). In particular, the security engine 140′ retrieves a portion of the stored data from the sharing-ring buffer for decrypting the retrieved data. The input data, the retrieved data and the decrypted data within a single burst are stored in the sharing-ring buffer (e.g., the FIFO 114 in this situation), and the spaces for allocating the input data, the retrieved data and the decrypted data in the sharing-ring buffer are dynamically adjusted. Additionally, the DMA processor such as the QMU/DMA engine 150′ is arranged to access the sharing-ring buffer (e.g., the FIFO 114 in this situation) to obtain the decrypted data for processing.

The PDU parser 112 is arranged to parse the input data into a plurality of PDUs and is arranged to store each PDU into at least a portion of the buffering regions. In particular, the PDU parser 112 is arranged to parse the input data and the decrypted data to the buffering regions of the sharing-ring buffer (e.g., the FIFO 114 in this situation). The CID table search engine 160 is arranged to determine whether a CID of each of the parsed data matches a CID in a CID table of the CID table search engine 160. When the CID of the parsed data does not match any CID in the CID table, the PDU parser 112 discards the parsed data. For example, the CID table is implemented with the CID table 162 mentioned above. The CID table search engine 160 is arranged to determine whether a CID of the input data matches a CID in the CID table 162. When the CID of the input data does not match any CID in the CID table 162, the PDU parser 112 discards the input data without storing into the sharing-ring buffer.

Please note that the operation of determining whether the CID of each of the parsed data matches the CID in the CID table of the CID table search engine 160 is performed prior of the CID table search engine 160 accessing into the sharing-ring buffer (e.g., the FIFO 114 in this situation). The PDU parser 112 further checks a Header Check Sequence (HCS) to determine if the received data is valid. Typically, the PDU parser 112 checks whether a correct HCS exists in each PDU and checks a Cyclic redundancy check indicator (CRC indicator) of the each PDU, and stores the PDUs into the sharing-ring buffer (e.g., the FIFO 114 in this situation) only if the PDUs comprise the correct HCS and comprises the matched CID.

Please note that the MAC-PHY interface 130′, the security engine 140′ and the DMA processor such as the QMU/DMA engine 150′ are the aforementioned logically successive stages of the Rx path of the wireless communication system. According to this embodiment, the aforementioned processing circuits 130, 140 and 150 are respectively implemented as these logically successive stages of the Rx path of the wireless communication system, where the processing circuits 130, 140 and 150 emulate the logically successive stages of the Rx path by accessing a plurality of buffering regions of the sharing-ring buffer (e.g., the FIFO 114 in this situation) in accordance with overlapped processing phases regarding the Rx path.

In a situation where the apparatus 100′ performs the uplink processing, the DMA processor such as the QMU/DMA engine 150′ is arranged to receive input data and is arranged to store the input data into the sharing-ring buffer, where the input data is in a PDU format and is stored into the sharing-ring buffer. More particularly, the DMA processor such as the QMU/DMA engine 150′ stores the input data into the FIFO 124 in this situation. In addition, the security engine 140′ is arranged to retrieve the stored data from the sharing-ring buffer (e.g., the FIFO 124 in this situation) and is arranged to encrypt the retrieved data, where the encrypted data is stored into the sharing-ring buffer (e.g., the FIFO 124 in this situation) and the encrypted data is translated into a data burst format prior of storing into the sharing-ring buffer. In particular, the security engine 140′ retrieves a portion of the stored data from the sharing-ring buffer for decrypting the retrieved data. The input data, the retrieved data and the encrypted data within a single burst are stored in the sharing-ring buffer (e.g., the FIFO 124 in this situation), and the spaces for allocating the input data, the retrieved data and the encrypted data in the sharing-ring buffer are dynamically adjusted.

Additionally, the MAC-PHY interface 130′ is arranged to receive the encrypted data from the sharing-ring buffer (e.g., the FIFO 124 in this situation). Typically, the MAC-PHY interface 130′ is arranged to access the sharing-ring buffer (e.g., the FIFO 124 in this situation) to obtain the encrypted data for transmitting the encrypted data to the baseband circuit mentioned above, which is implemented as the WiMAX PHY circuit 108′ in this embodiment. Furthermore, the PDU parser 122 is arranged to parse the stored data and is arranged to store the parsed data into the buffering region (e.g., the FIFO 124 in this situation).

Please note that the DMA processor such as the QMU/DMA engine 150′, the security engine 140′ and the MAC-PHY interface 130′ are the aforementioned logically successive stages of the Tx path of the wireless communication system. According to this embodiment, the aforementioned processing circuits 150, 140 and 130 are respectively implemented as these logically successive stages of the Tx path of the wireless communication system, where the processing circuits 150,140 and 130 emulate the logically successive stages of the Tx path by accessing a plurality of buffering regions of the sharing-ring buffer (e.g., the FIFO 124 in this situation) according to a pointer in accordance with overlapped processing phases regarding the Tx path.

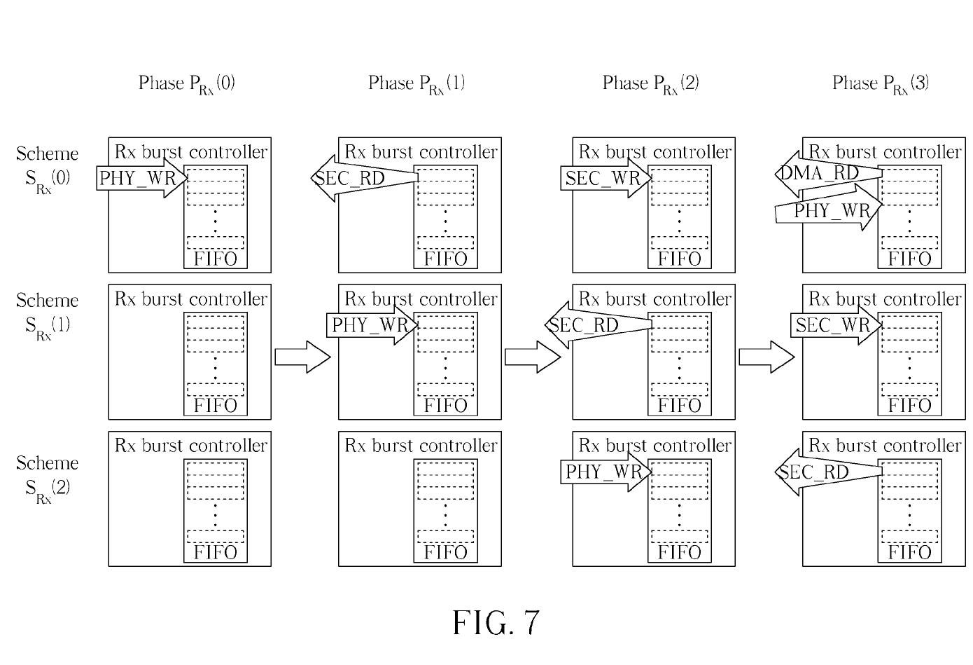

FIG. 7 illustrates overlapped processing phases P_{Rx}(i_{Rx}) of respective schemes S_{Rx}(j_{Rx}) of the Rx burst controller shown in FIG. 6 according to a special case of the embodiment shown in FIG. 6, where i_{Rx}=0, 1, 2, 3, . . . , and so on, and j_{Rx}=0, 1, . . . , and N_j_{Rx} with N_j_{Rx} being 2 in this special case. Here, in each of the processing phases P_{Rx}(i_{Rx}) of the respective schemes S_{Rx}(j_{Rx}), the blocks illustrated by utilizing dashed lines within the FIFO (i.e. the FIFO 114 shown in FIG. 6) represents the buffering regions in the FIFO 114. Regarding the buffer access on the buffering regions 114R, PHY_WR represents a write command of the MAC-PHY interface 130′, SEC_RD represents a read command of the security engine 140′, SEC_WR represents a write command of the security engine 140′, and DMA_RD represents a read command of the QMU/DMA engine 150′. In this embodiment, one or more sub-units of data of a received PDU (e.g., one or more bytes) are temporarily stored in each of the buffering regions that are involved, such that the transition time from one processing phase to another is very short. That is, the respective operations of the MAC-PHY interface 130′, the security engine 140′, and the QMU/DMA engine 150′ are almost performed at the same time, without waiting for the completion of the whole processing for a PDU from each other. Therefore, the overall operational speed of the wireless communication system is much higher than that in the related art.

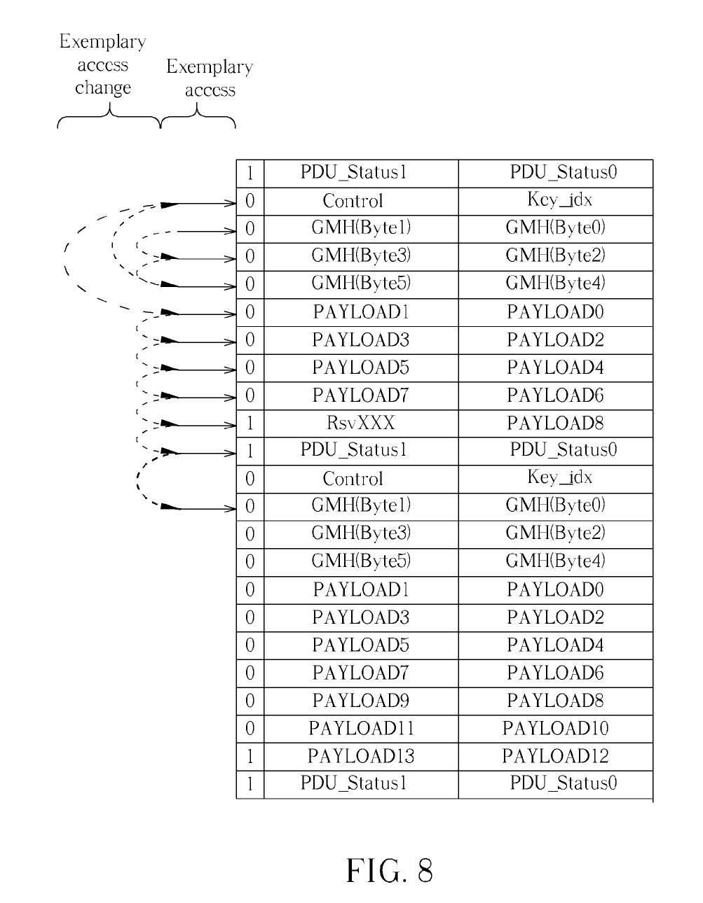

FIG. 8 illustrates the buffer structure for the Rx burst controller 110 shown in FIG. 6. Here, the PDU status parameters PDU_Status1 and PDU_Status0 in the buffer structure represent the status of a PDU. It should be noted that the PDU status parameters PDU_Status1 and PDU_Status0 comprise information that may be altered or updated by one or more components within the WiMAX MAC module 100M′ (e.g., the PDU parser 112, the MAC-PHY interface 130′, the security engine 140′, and/or the QMU/DMA engine 150′), so one component may determine whether to start accessing the data of this PDU according to the PDU status parameters. In addition, the parameters GMH(Byte5), GMH(Byte4), . . . , and GMH(Byte0) can be utilized for representing Generic MAC Header (GMH), and can also be utilized for temporarily storing the detection results of the HCS detection operation and/or the CID detection operation, where the content in the parameters GMH(Byte5), GMH(Byte4), . . . , and GMH(Byte0) can be directly overwritten with another PDU's GMH if the original PDU does not pass the HCS detection operation and/or the CID detection operation. Thus, the PDU parser 112 and/or the security engine 140′ may determine whether to start their own access for the following data. Additionally, the parameter Key_idx represents a key index corresponding to a key utilized by the security engine 140′, so that multiple schemes such as those shown in FIG. 7 can be properly implemented.

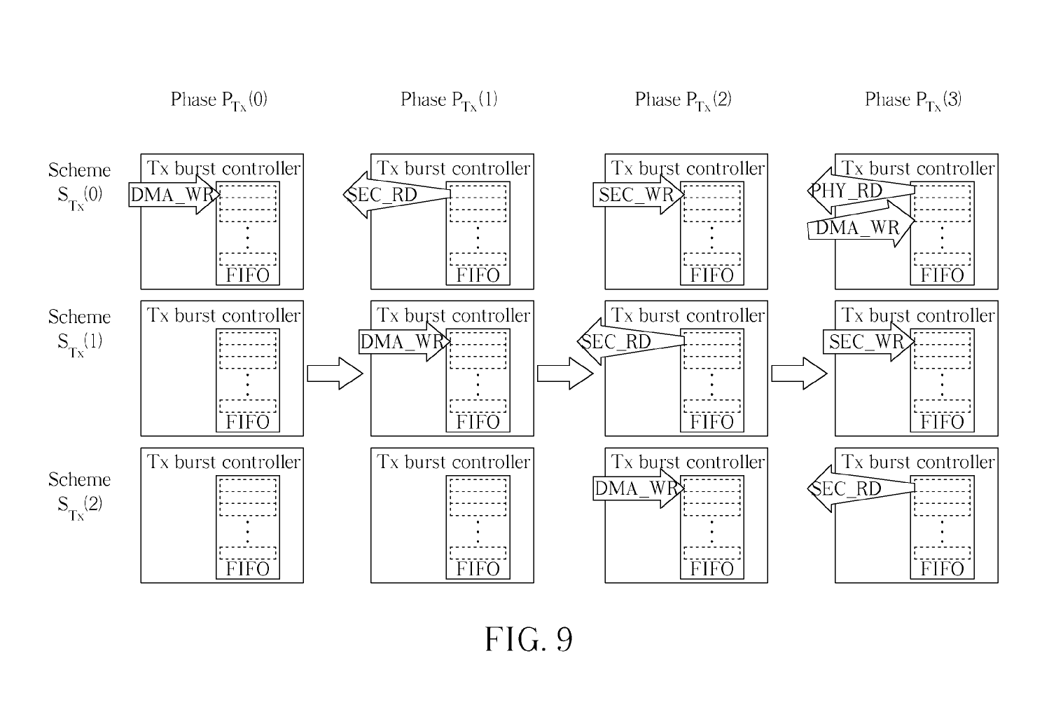

FIG. 9 illustrates overlapped processing phases P_{Tx}(i_{Tx}) of respective schemes S_{Tx}(j_{Tx}) of the Tx burst controller shown in FIG. 6 according to another special case of the embodiment shown in FIG. 6, where i_{Tx}=0, 1, 2, 3, . . . , and so on, and j_{Tx}=0, 1, 2, . . . , and N_j_{Tx} with N_j_{Tx} being 2 in this special case. Here, in each of the processing phases P_{Tx}(i_{Tx}) of the respective schemes S_{Tx}(j_{Tx}), the blocks illustrated by utilizing dashed lines within the FIFO (i.e. the FIFO 124 shown in FIG. 6) represents the buffering regions in the FIFO 124. Regarding the buffer access on the buffering regions 124R, DMA_WR represents a write command of the QMU/DMA engine 150′, SEC_RD represents a read command of the security engine 140′, SEC_WR represents a write command of the security engine 140′, and PHY_RD represents a read command of the MAC-PHY interface 130′. As in this embodiment, one or more sub-units of data of a PDU (e.g., one or more bytes) are temporarily stored in each of the buffering regions that are involved; the transition time from one processing phase to another is very short. That is, the respective operations of the QMU/DMA engine 150′, the security engine 140′, and the MAC-PHY interface 130′ are almost performed at the same time, without waiting for the completeness of the whole processing for a PDU from each other. Therefore, the overall operational speed of the wireless communication system is much higher than that in the related art.

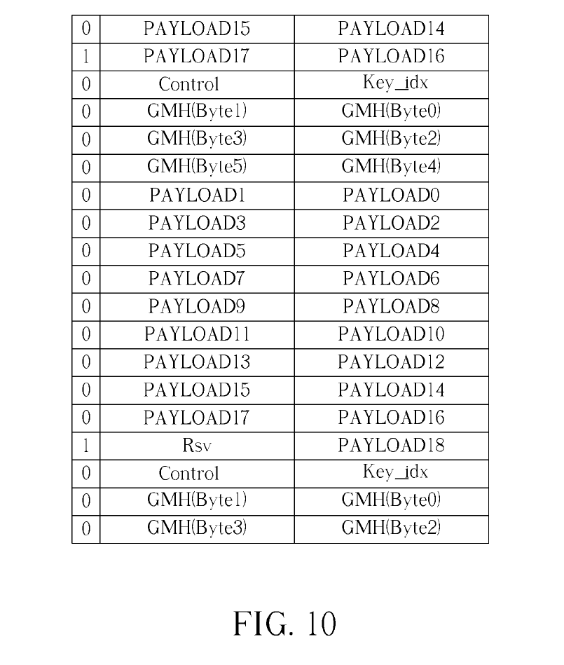

FIG. 10 illustrates the buffer structure for the Tx burst controller 120 shown in FIG. 6. As the operations for the Tx path are the reversed operations for the Rx path with the data paths R0, R1, . . . , and R7 respectively corresponding to the data paths T7, T6, . . . , and T0, similar descriptions are not repeated for the Tx path.

It should be noted that in the first embodiment, although one buffer is utilized for implementing each path (e.g. the Rx path or the Tx path) of the wireless communication system, this is not a limitation of the present invention. According to a variation of the first embodiment, the number of buffers for each path (e.g. the Rx path or the Tx path) can be more than one. According to another variation of the first embodiment, only one buffer is utilized for both the Rx path and the Tx path.

According to another variation of the first embodiment, the size of each buffering region can be varied as needed, so as to achieve the most optimized utilization of each buffer.

In contrast to the related art, the present invention apparatus and related methods provide an increased overall operational speed of the wireless communication system, and therefore, better performance than the related art.

It is another advantage of the present invention that the size of the wireless communication system can be greatly decreased without hindering the respective operations of the logically successive stages of the Rx/Tx path of the wireless communication system.

Those skilled in the art will readily observe that numerous modifications and alterations of the device and method may be made while retaining the teachings of the invention.

What is claimed is:

1. An apparatus for performing a downlink processing in a wireless communication system to maintain the efficiency of system bandwidth, the apparatus comprising:
a sharing-ring buffer for storing multi-format data;
a Medium Access Control and Physical layers (MAC-PHY) interface for receiving input data, wherein the input data comprises at least a data burst, is in a data burst format and is stored into the sharing-ring buffer;
a security engine for retrieving the stored data from the sharing-ring buffer and decrypting the retrieved data, wherein the decrypted data is in a protocol data unit (PDU) format and stored into the sharing-ring buffer; and
a direct memory access (DMA) processor for accessing the sharing-ring buffer to obtain the decrypted data.

2. The apparatus of claim 1, wherein the sharing-ring buffer comprises a plurality of buffering regions.

3. The apparatus of claim 2, further comprising:
a protocol data unit (PDU) parser, coupled to the sharing-ring buffer, for parsing the input data into a plurality of PDUs and storing each PDU into at least a portion of the buffering regions.

4. The apparatus of claim 3, further comprising:
a connection identification (CID) table search engine, coupled to the PDU parser, for determining whether a CID of each of the parsed data matches a CID in a CID table of the CID table search engine;
wherein when the CID of the parsed data does not match any CID in the CID table, the PDU parser discards the parsed data.

5. The apparatus of claim 4, wherein determining whether the CID of each of the parsed data matches the CID in the CID table of the CID table search engine is performed prior of the CID table search engine accessing into the sharing-ring buffer.

6. The apparatus of claim 5, wherein the PDU parser further checks whether a correct Header Check Sequence (HCS) exists in the each PDU and checks a Cyclic redundancy check indicator (CRC indicator) of the each PDU, and stores the PDUs into the sharing-ring buffer only if the PDUs comprise the correct HCS and comprises the matched CID.

7. The apparatus of claim 1, wherein the security engine retrieves a portion of the stored data from the sharing-ring buffer for decrypting the retrieved data.

8. The apparatus of claim 1, wherein the input data, the retrieved data and the decrypted data within a single burst are stored in the sharing-ring buffer, and spaces for allocating the input data, the retrieved data and the decrypted data in the sharing-ring buffer are dynamically adjusted.

9. The apparatus of claim 1, wherein the MAC-PHY interface, the security engine and the DMA processor are logically successive stages of a receiving (Rx) path of the wireless communication system; and the apparatus comprises:
a plurality of processing circuits, coupled to the sharing-ring buffer, for implementing the logically successive stages of the Rx path of the wireless communication system, respectively, wherein the processing circuits emulate the logically successive stages of the Rx path by accessing a plurality of buffering regions of the sharing-ring buffer in accordance with overlapped processing phases.

10. An apparatus for performing an uplink processing in a wireless communication system to maintain the efficiency of system bandwidth, the apparatus comprising:
a sharing-ring buffer for storing multi-format data;
a direct memory access (DMA) processor for receiving input data and storing the input data into the sharing-ring buffer, wherein the input data is in a protocol data unit (PDU) format and is stored into the sharing-ring buffer;
a security engine for retrieving the stored data from the sharing-ring buffer and encrypting the retrieved data, wherein the encrypted data is stored into the sharing-ring buffer and the encrypted data is translated into a data burst format prior of storing into the sharing-ring buffer; and
a Medium Access Control and Physical layers (MAC-PHY) interface for receiving the encrypted data from the sharing-ring buffer.

11. The apparatus of claim 10, wherein the security engine retrieves a portion of the stored data from the sharing-ring buffer for encrypting the retrieved data.

12. The apparatus of claim 11, wherein the sharing-ring buffer comprises a plurality of buffering regions.

13. The apparatus of claim 12, further comprising:
a protocol data unit (PDU) parser, coupled to the sharing-ring buffer, for parsing the stored data and storing the parsed data into the buffering region.

14. The apparatus of claim 10, wherein the input data, the retrieved data and the encrypted data within a single burst are stored in the sharing-ring buffer, and spaces for allocating the input data, the retrieved data and the encrypted data in the sharing-ring buffer are dynamically adjusted.

15. The apparatus of claim 10, wherein the DMA processor, the security engine and the MAC-PHY interface are logically successive stages of a transmitting (Tx) path of the wireless communication system; and the apparatus comprises:
a plurality of processing circuits, coupled to the sharing-ring buffer, for implementing the logically successive stages of the Tx path of the wireless communication system, respectively, wherein the processing circuits emulate the logically successive stages of the Tx path by accessing a plurality of buffering regions of the sharing-ring buffer according to a pointer in accordance with overlapped processing phases.

16. A method for processing data in a wireless communication system, the method comprising:
providing a sharing-ring buffer for storing multi-format data;
receiving input data, wherein the input data comprises at least a data burst and the input data is stored into the sharing-ring buffer;
retrieving the stored data from the sharing-ring buffer;
decrypting the retrieved data and storing the decrypted data into the sharing-ring buffer; and
accessing the sharing-ring buffer to obtain the decrypted data for processing.

17. The method of claim 16, wherein the sharing-ring buffer comprises a plurality of buffering regions, and the method further comprises:
parsing the input data and the decrypted data to the buffering regions of the sharing-ring buffer.

18. The method of claim 17, further comprising:
checking a Header Check Sequence (HCS) to determine if the received data is valid;
providing a connection identification (CID) table to determine whether a CID of the input data matches a CID in the CID table; and
when the CID of the input data does not match any CID in the CID table, discarding the input data without storing into the sharing-ring buffer.

19. A method for processing data in a wireless communication system, the method comprising:
providing a sharing-ring buffer for storing at least one type of data;
receiving input data, wherein the input data are in a protocol data unit (PDU) format and the input data is stored into the sharing-ring buffer;
retrieving the stored data from the sharing-ring buffer;
encrypting the retrieved data and storing the encrypted data into the sharing-ring buffer, wherein the encrypted data is in a data burst format; and
accessing the sharing-ring buffer to obtain the encrypted data for transmitting the encrypted data to a baseband circuit.
